(19) United States
(12) Patent Application Publication
(10) Pub. No.: US 2006/0120615 A1
(43) Pub. Date: Jun. 8, 2006

(54) Frame compensation for moving imaging devices

(76) Inventors: Huiqiong Wang, Hangzhou (CN); Yiqing Jin, Hangzhou (CN); Donghui Wu, Fremont, CA (US)

Correspondence Address: PATENT LAW GROUP LLP, 2635 NORTH FIRST STREET, SUITE 223, SAN JOSE, CA, 95134, US

(21) Appl. No.: 11/006,319

(22) Filed: Dec. 6, 2004

(51) Int. Cl. G06K 9/40

(52) U.S. Cl. 382/254

(57) ABSTRACT

A method for stabilizing a video comprising includes transforming a current frame to remove an unwanted camera motion from the current frame, cropping a portion of the transformed current frame located outside a field of view, transforming preceding and subsequent frames to place them into the local coordinate system of the current frame and to remove the unwanted camera motion from the preceding and the subsequent frames, and filling at least one blank area of the field of view with at least one of the transformed preceding and subsequent frames.

### CROSS REFERENCE TO RELATED APPLICATIONS

This application is related to U.S. application Ser. No. 10/003,329, attorney docket no. M-12237 US (ARC-P109), entitled “VIDEO STABILIZER,” filed Oct. 31, 2001, which is commonly assigned and incorporated by reference in its entirety.

### FIELD OF INVENTION

This invention relates to digital image processing that stabilizes video.

### DESCRIPTION OF RELATED ART

FIG. 1 illustrates a method 100 for conventional software to stabilize video. In step 102, a frame 10A from a video is transformed (e.g., translated and rotated) to form a frame 10B so that a jittering effect from any unwanted camera motion is removed from the video. As a result, part of frame 10B is located outside of a field of view 12 that is displayed to the user. In step 104, frame 10B is cropped to form a frame 10C located inside field of view 12 and having the same aspect ratio as field of view 12. In step 106, frame 10C is resized to form a frame 10D that fills field of view 12.

One of the disadvantages is that when the video is displayed to the user, the user may experience a zoom-in and zoom-out effect when the frames are cropped and resized repeatedly. On the other hand, if the frames are not cropped and resized, the frames may have blank areas that are displayed to the user as a result of the transformation to remove any unwanted camera motion. Thus, what is needed is a method for stabilizing video that addresses these challenges.

### BRIEF DESCRIPTION OF THE DRAWINGS

FIG. 1 illustrates a conventional method for stabilizing a video.

FIGS. 2, 3, and 4 illustrate a method for stabilizing a video in one embodiment of the invention.

FIG. 5 illustrates a method for compensating the cropped frames generated when stabilizing a video in one embodiment of the invention.

FIGS. 6, 7, 8, and 9 graphically illustrate the steps in the method of FIG. 5 in one embodiment of the invention.

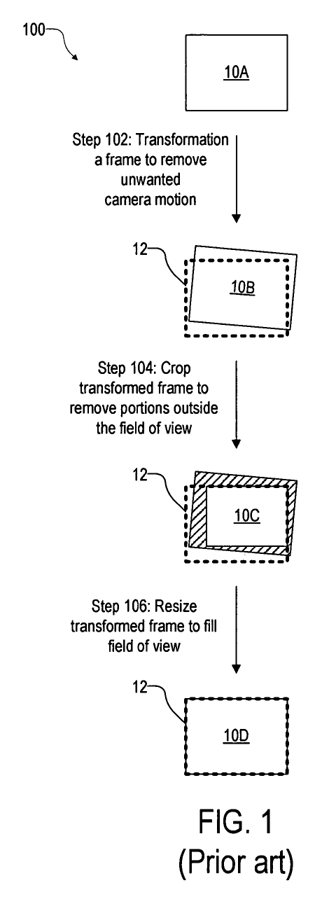

Use of the same reference numbers in different figures indicates similar or identical elements.

### SUMMARY

In one embodiment of the invention, a method for stabilizing a video comprising includes transforming a current frame to remove an unwanted camera motion from the current frame, cropping a portion of the transformed current frame located outside a field of view, transforming preceding and subsequent frames to place them into the local coordinate system of the current frame and to remove the unwanted camera motion from the preceding and the subsequent frames, and filling at least one blank area of the field of view with at least one of the transformed preceding and subsequent frames.

### DETAILED DESCRIPTION

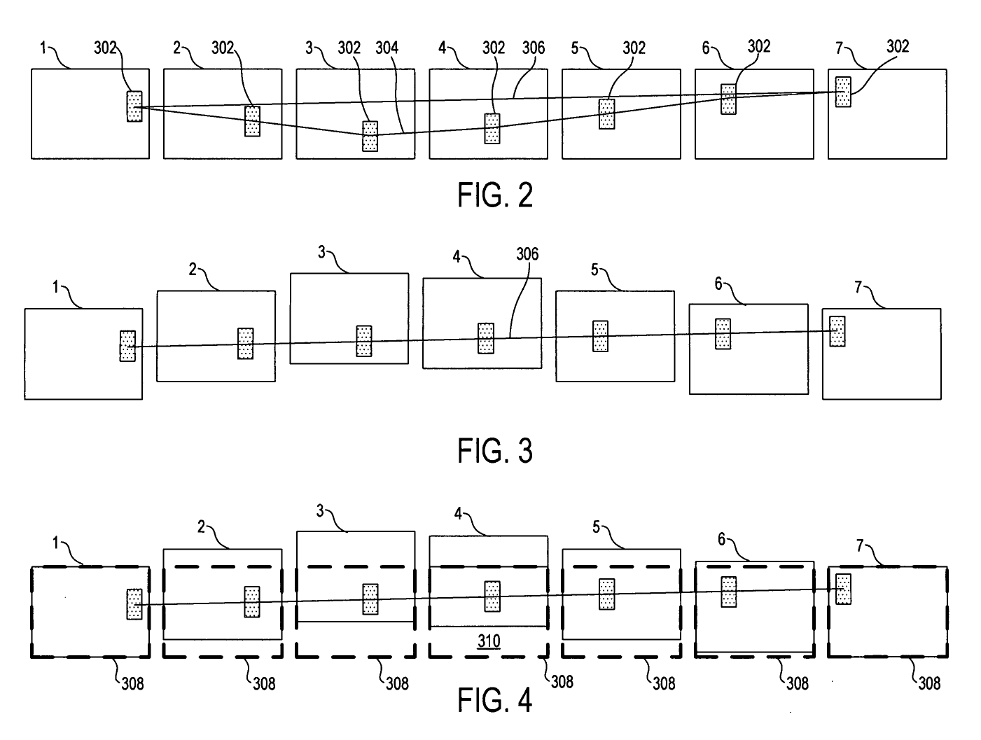

FIGS. 2, 3, and 4 illustrate a method for removing unwanted camera motion from a video in one embodiment of the invention.

FIG. 2 illustrates frames 1, 2, 3, 4, 5, 6, and 7 in a video. The camera motion between the frames can be determined by matching common points of interests (POIs) between consecutive frames. For simplicity, common POIs between consecutive frames 1 to 7 are represented by an object 302 in each frame and only a translational camera motion is illustrated. A line 304 drawn through objects 302 in frames 1 to 7 represents the actual camera motion. Once common POIs between consecutive frames are determined, an Affine transform can be determined for each pair of consecutive frames that places all the pixels in the preceding frame into the local coordinate system of the subsequent frame (hereafter referred to as “inter-frame transform”). The Affine transform is determined so that the correspondence between the consecutive frames can be refined to better estimate the actual camera motion.

A line 306 interpolated (linearly or nonlinearly) through objects 302 in frames 1 to 7 represents the idealized camera motion, which is the actual camera motion minus any unwanted camera motion. Once the idealized camera motion is determined, an Affine transform can be determined for each frame that places that frame along the idealized camera motion 306 (hereafter referred to as “stabilizing transform”). FIG. 3 illustrates frames 1 through 7 placed along the idealized camera motion 306.

Once frames 1 to 7 are placed along the idealized camera motion 306, portions of frames outside of their original field of views (FOVs) 308 (illustrated as dashed boxes in FIG. 4) are cropped. FIG. 4 illustrates the cropping of frames 1 through 7. The cropping of the frames may leave areas of FOVs 308 blank for each frame. For example, FOV 308 for frame 4 has a blank area 310 that needs to be filled in to generate a complete frame. As discussed in the background, resizing the cropped frame produces an undesirable zooming effect to the user.

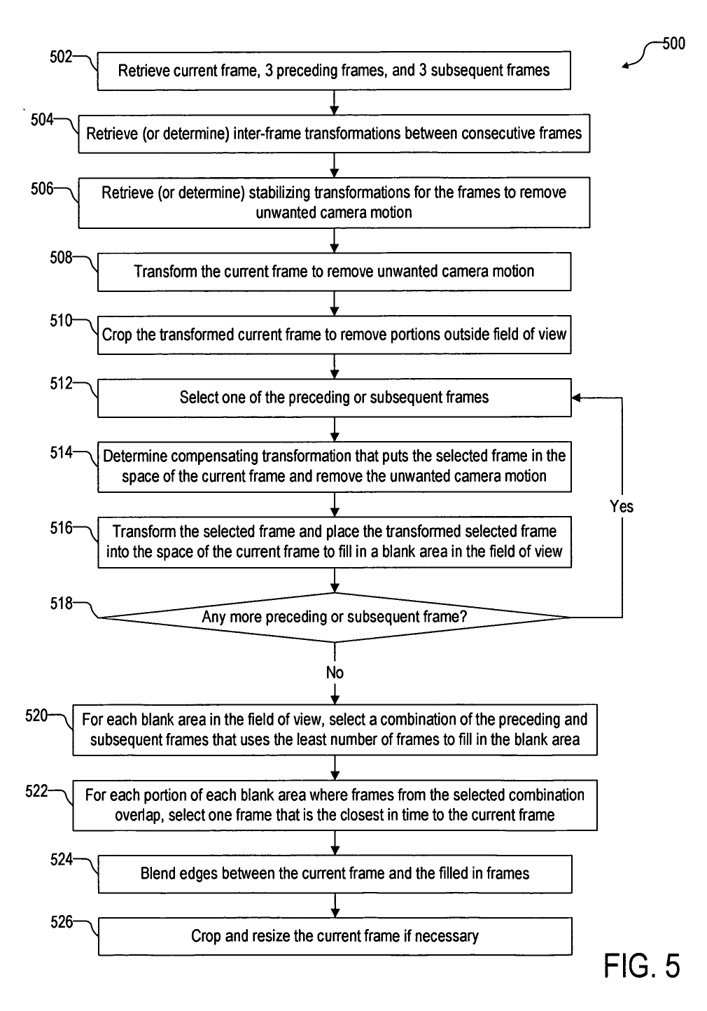

FIG. 5 is a flowchart of a method 500 for stabilizing a video in one embodiment of the invention. Method 500 may be implemented in software executed by a computer or any equivalents thereof.

In step 502, seven frames of a video are retrieved. For example, frames 1, 2, 3, 4, 5, 6, and 7 (FIG. 2) are retrieved. Frame 4 is the current frame that will be transformed to remove the effect of any unwanted camera motion without producing the undesirable zooming effect to the user. Preceding frames 1 to 3 and subsequent frames 5 to 7 will be used to fill in blank areas left by the transformed frame 4 in the field of view.

In step 504, the inter-frame transforms between consecutive frames are determined or retrieved if they have been previously determined. As described above, the inter-frame transforms can be determined from common POIs between consecutive frames.

In step 506, the stabilizing transform for current frame 4 is determined or retrieved if it has been previously determined. As described above, the stabilizing transform can be determined from the idealized camera motion 306.

In step 508, current frame 4 is transformed using the stabilizing transform to remove the unwanted camera motion from current frame 4.

In step 510, current frame 4 is cropped to remove portions outside FOV 308. This leaves blank area 310 in FOV 308. Current frame 4 may have more than one blank area under other circumstances.

In step 512, one of preceding frames 1, 2, 3 and subsequent frames 5, 6, 7 is selected.

In step 514, an Affine transform that places the selected frame in the local coordinate system of current frame 4 and removes the unwanted camera motion from the selected frame is determined (hereafter referred to as “compensating transform”). The compensating transform is determined from the known inter-frame transforms and the known stabilizing transform.

The inter-frame transform between frames 3 and 4 is:

$$\begin{matrix}{\vec{X}}_{4} = {R}^{( 3 , 4 )} {\vec{X}}_{3} + {\vec{t}}^{( 3 , 4 )} , or & ( 1 ) \\ \vert \begin{matrix}{x}_{4} \\ {y}_{4}\end{matrix} \vert = \vert \begin{matrix}cos {θ}^{( 3 , 4 )} & - sin {θ}^{( 3 , 4 )} \\ sin {θ}^{( 3 , 4 )} & cos {θ}^{( 3 , 4 )}\end{matrix} \vert \vert \begin{matrix}{x}_{3} \\ {y}_{3}\end{matrix} \vert + \vert \begin{matrix}{t}_{x}^{( 3 , 4 )} \\ {t}_{y}^{( 3 , 4 )}\end{matrix} \vert , & ( 2 )\end{matrix}$$

where x₃ and y₃ are the coordinates of a pixel in frame 3, θ^{(3,4)} is the rotation between from frame 3 to frame 4, tₓ^{(3,4)} and t_{y}^{(3,4)} are the translation from frame 3 to frame 4, and x₄ and y₄ coordinates of the pixel from frame 3 in the local coordinate system of frame 4.

The stabilizing transform for current frame 4 is:

$$\begin{matrix}{\vec{X}}_{4}^{′} = {R}^{( 4 )} {\vec{X}}_{4} + {\vec{t}}^{( 4 )} , or & ( 3 ) \\ \vert \begin{matrix}{x}_{4}^{′} \\ {y}_{4}^{′}\end{matrix} \vert = \vert \begin{matrix}cos {θ}^{( 4 )} & - sin {θ}^{( 4 )} \\ sin {θ}^{( 4 )} & cos {θ}^{( 4 )}\end{matrix} \vert \vert \begin{matrix}{x}_{4} \\ {y}_{4}\end{matrix} \vert + \vert \begin{matrix}{t}_{x}^{( 4 )} \\ {t}_{y}^{( 4 )}\end{matrix} \vert , & ( 4 )\end{matrix}$$

where θ⁽⁴⁾ is the rotation of frame 4 to remove unwanted camera motion, tₓ^{(3,4)} and t_{y}^{(3,4)} are the translation of frame 4 to remove unwanted camera motion, and x₄′ and y₄′ are the coordinates of a transformed pixel from frame 4 after the removal of the unwanted camera motion.

Thus, equation 1 is substituted in equation 3 to determine a compensating transform for frame 3 as follows:
\vec{X}₄′=R⁽⁴⁾(R^{(3,4)}\vec{X}₃+\vec{t}^{(3,4)})+t⁽⁴⁾, or (5)
\vec{X}₄′=R⁽⁴⁾R^{(3,4)}\vec{X}₃+R⁽⁴⁾\vec{t}^{(3,4)}+\vec{t}⁽⁴⁾. (6)

As one skilled in the art understands, the selection of frames that are more than once removed from current frame 4 would require the substitution of that frame's inter-frame transform into one or more additional inter-frame transforms of its neighboring frames up to current frame 4.

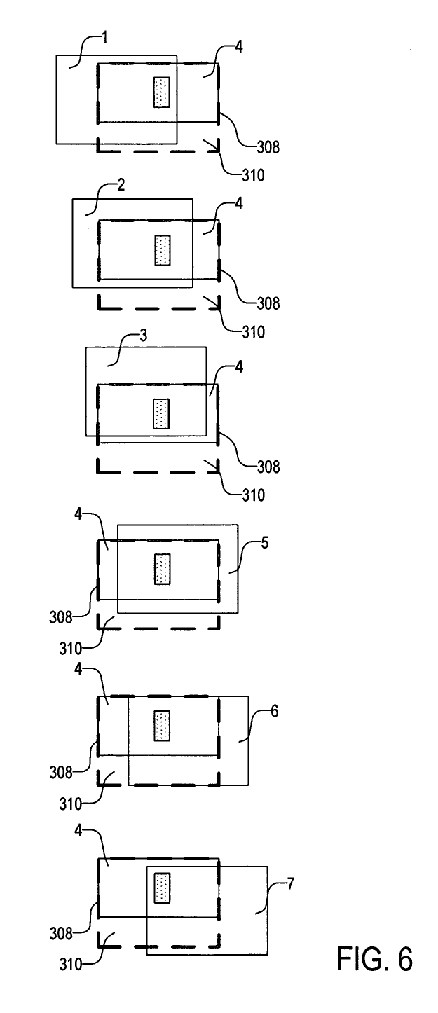

In step 516, the selected frame is transformed using the compensating transform. FIG. 6 illustrates the transformation of frames 1 to 3 and 5 to 7 and their relationship with current frame 4.

In step 518, it is determined if there is any remaining preceding or subsequent frame. If so, then step 518 is followed by step 512 and method 500 repeats until all of the preceding and subsequent frames are placed in the local coordinate system of current frame 4 and the unwanted camera motion removed from them. If there is no remaining preceding or subsequent frame, then step 518 is followed by step 520.

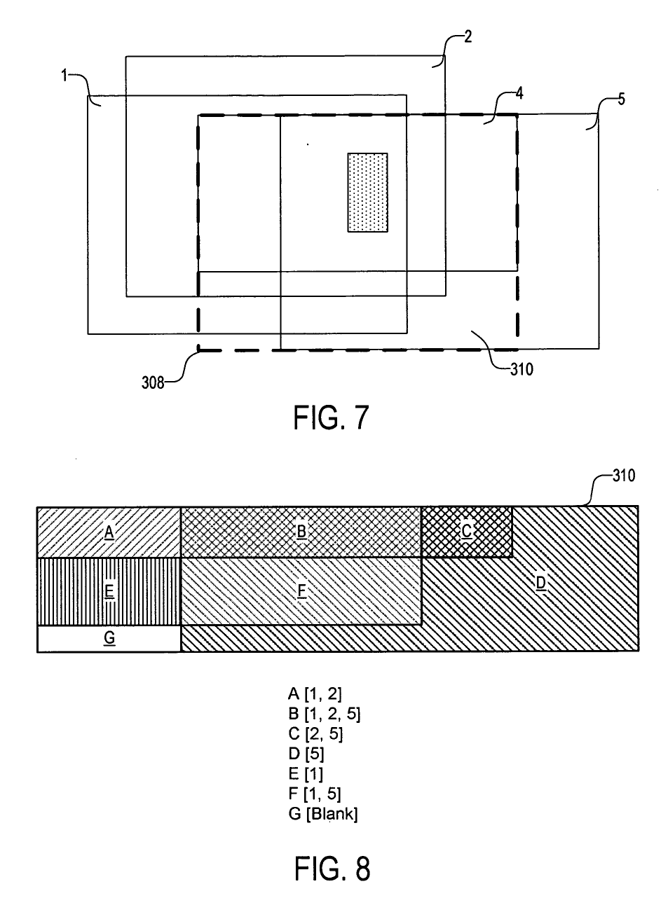

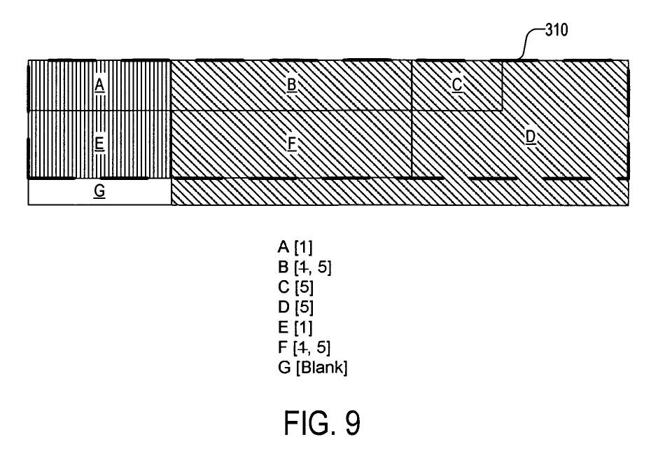

In step 520, a combination of the preceding and subsequent frames that uses the least number of frames to fill in blank area 310 in FOV 308 is selected. For simplicity, assume that only frames 1, 2, and 5 appear in blank area 310 as illustrated in FIG. 6. The overlapping areas A, B, C, D, E, and F of these frames in blank area 310 are shown enlarged in FIG. 7. Specifically, frame 1 is illustrated with a vertical pattern, frame 2 is illustrated with a diagonal pattern (from lower left to upper right), and frame 5 is illustrated with another diagonal pattern (upper left to lower right). As can be seen, only frames 1 and 5 are necessary to fill in blank area 310, whereas frame 2 can be replaced in any of the overlapping area it appears with either frame 1 or 5. Thus, the least number of frames to fill in blank area 310 requires a combination of frames 1 and 5.

In step 522, for each overlapping area in blank area 310, the frame that is the closest in time to current frame 4 is selected. If two frames are equally close in time, then one of the frames is selected randomly. As illustrated in FIG. 8, in the overlapping areas of frames 1 and 5, frame 5 is selected over frame 1 because it is closer in time to current frame 4.

In step 524, edges between current frame 4 and the filled in blank area 310 are blended to create a more natural merge of the different frames in the resulting frame 4.

In step 526, the resulting frame 4 is cropped and resized if there are any remaining blank areas in the field of view. Referring back to FIG. 8, area G in blank area 310 remains blank. Thus, the resulting frame 4 is cropped to remove area G and then resized to fill FOV 308. Method 500 may then be repeated for each frame in the video.

Various other adaptations and combinations of features of the embodiments disclosed are within the scope of the invention. Numerous embodiments are encompassed by the following claims.

What is claimed is:

1. A method for stabilizing a video comprising a plurality of frames, the plurality of frames including a current frame, a plurality of preceding frames, and a plurality of subsequent frames, the method comprising:
transforming the current frame to remove an unwanted camera motion from the current frame (hereafter “the transformed current frame”);
cropping a portion of the transformed current frame located outside a field of view;
transforming the preceding and the subsequent frames (1) to place them into the local coordinate system of the current frame and (2) to remove the unwanted camera motion from the preceding and the subsequent frames (hereafter “the transformed preceding and subsequent frames”); and
filling at least one blank area of the field of view with at least one of the transformed preceding and subsequent frames.

2. The method of claim 1, wherein said filling at least one blank area of the field of view comprises:
determining a combination of frames from the transformed preceding and subsequent frames that uses the least number of frames to fill in said at least one blank area; and
for each portion of said at least one blank area where two or more frames from the combination overlap, selecting a frame from the two or more frames that is the closest in time to the current frame to fill in said each portion.

3. The method of claim 2, further comprising blending edges of the transformed current frame and frames selected from the transformed preceding and subsequent frames used to fill in said at least one blank area.

4. The method of claim 2, further comprising:
if said at least one blank area still has a portion that is blank after said filling (hereafter “blank portion”), then cropping the field of view to remove the blank portion and resizing the field of view to its original size.
